(19) United States
(12) Patent Application Publication
(10) Pub. No.: US 2009/0321220 A1
(43) Pub. Date: Dec. 31, 2009

(54) DEVICE FOR TREATMENT OF ARTICLES COMPRISING OVERLAPPING DRIVING DEVICES

(76) Inventor: Goran Ewerlof, Lidingo (SE)

Correspondence Address: STITES & HARBISON PLLC, 1199 NORTH FAIRFAX STREET, SUITE 900, ALEXANDRIA, VA, 22314, US

(21) Appl. No.: 12/373,058

(22) PCT Filed: Jun. 21, 2007
(86) PCT No.: PCT/SE07/50458

§ 371 Date: Jan. 9, 2009

(30) Foreign Application Priority Data
Jul. 10, 2006 (SE) 0601520-0

(51) Int. Cl. B65G 47/24

(52) U.S. Cl. 198/345.3

(57) ABSTRACT

The invention relates to a palette for supporting articles such as CDs, DVDs or the like, which is adapted to be guided forward on a conveyor path (2) on a device according to any of the proceeding claims, which comprises a wheel (44) or the like arranged to interact with a rail (3) along the conveyor path (2); a first pin (41) arranged to engage with a first driving element (22) on a first driving device (20) to drive the palette (4) forward along the rail (3) of the conveyor path (2); a second pin (42, 42′) arranged to engage with a second driving element (32, 32′) on a second driving device (30, 30′). The engagement of the first pin (41) with the first driving element (22) includes an allowance, which by means of the engagement between the second driving element (32, 32′) on the second driving device (30, 30′) allows the palette (4) to be displaced in respect of the first driving element (22), such that the palette may be driven forward by the second driving element (32, 32′) within said allowance. The invention relates also to a device for processing of articles, wherein the articles are guided forward on such a palette.

The invention concerns a device for processing of articles such as CDs, DVDs or the like. The invention also concerns a palette for supporting the article that is to be processed at the device.

### BACKGROUND

Today's methods for processing of CDs, in which e.g. a declaration of contents or a decorative colour print is printed on to the trackless side of the CDs, are almost completely automated. A pile of unprinted CDs is placed at the one end of a conveyor path at a printing device, and a pile of printed CDs is subsequently delivered at the other end. The difference between different devices of this kind is above all how many discs that may be printed under a certain period and the quality of the finished printing. Usually the discs are guided forward on so-called palettes or article carriers that are passing different processing stations where the discs are processed. If the palette is moving with a certain allowance in relation to the processing station the quality may suffer, since the possible allowance might give rise to corresponding aberrations in the printing. The allowance may be minimized by using a driving device with high accuracy, such as e.g. a worm conveyor or a linear motor to guide the palette forward alongside the processing stations. It is however not feasible with such a device to guide the palettes around the whole conveyor path since it is only capable of guiding the palettes straight a head. Therefore the device is usually furnished with a secondary driving device for driving the palettes along the remainder of the path.

### PRIOR ART

U.S. Pat. No. 4,667,804 (Dubuit) discloses a conveyor system arranged to provide various products with a printing. The products are guided forward by two different driving devices. One uncomplicated driving device for guiding the palettes forward where no processing stations are situated and one driving device with higher accuracy, which conveys the palettes past the processing stations.

Similarly, in U.S. Pat. No. 6,082,256 (Kammann), two different driving devices are combined; one consisting of an arrangement of a carousel type and the other consisting of a worm conveyor intended to move the CD unit through the portion in which the CD is being processed. The worm conveyor has a differentiated pitch, which allows it to stop at the curing points, where the printing is radiated by a UV-lamp.

Both these arrangements lack a completely reliable transfer mechanism so that the transfer from one conveyor system to the other could have been done smoothly. Instead, at both arrangements there is a certain risk that the transfer from one driving system to another is fails and that a product carrier will get stuck between the two driving systems whereupon several product carriers may be held up one after another behind the product carrier that has been stuck at said transfer.

### SHORT DESCRIPTION OF THE INVENTION

One purpose of the device according to the invention is to provide a reliable device for the processing of articles, such as CDs or the like, in which the transport of articles past the processing stations is performed with the highest possible accuracy, and in which the design of the device is such that it minimizes the risk that the palettes get stuck somewhere along the conveyor path.

Another purpose of the invention is to provide a device, in which a great number of discs may be processed at a certain unit of time with maintained quality.

These purposes are fulfilled by means of a device according to claim 1 and by the palette according to claim 7. As a first driving device according to the invention in these claims is capable of driving a palette all along the conveyor path, the risk that a palette gets stuck at the transfer between two driving devices is minimized.

Preferred embodiments of the invention are presented in the dependent claims.

### SHORT DESCRIPTION OF THE DRAWINGS

The invention will be explained in more detail below with references to the drawings, in which:

FIG. 1 is a schematic view of a device according to the invention;

FIG. 2 is a view of two picking devices for application of unprocessed articles and removal of processed articles to and from the conveyor path of the device;

FIG. 3 is a view of a device partly in cross section in the stage where a first embodiment of a second driving device is taking over the driving of the palette;

FIG. 4 is the same view as in FIG. 3, but in a stage when the second driving device is driving the palette on its own;

FIG. 5 is a view straight from below of the palette according to the invention;

FIG. 6 shows a cross section along A-A in FIG. 5;

FIG. 7 is a side view of a second embodiment of the second driving device;

FIG. 8 shows the second embodiment from the side and from below;

FIG. 9 shows an enlargement of a portion of FIG. 8.

### DETAILED DESCRIPTION OF THE SHOWED EMBODIMENTS

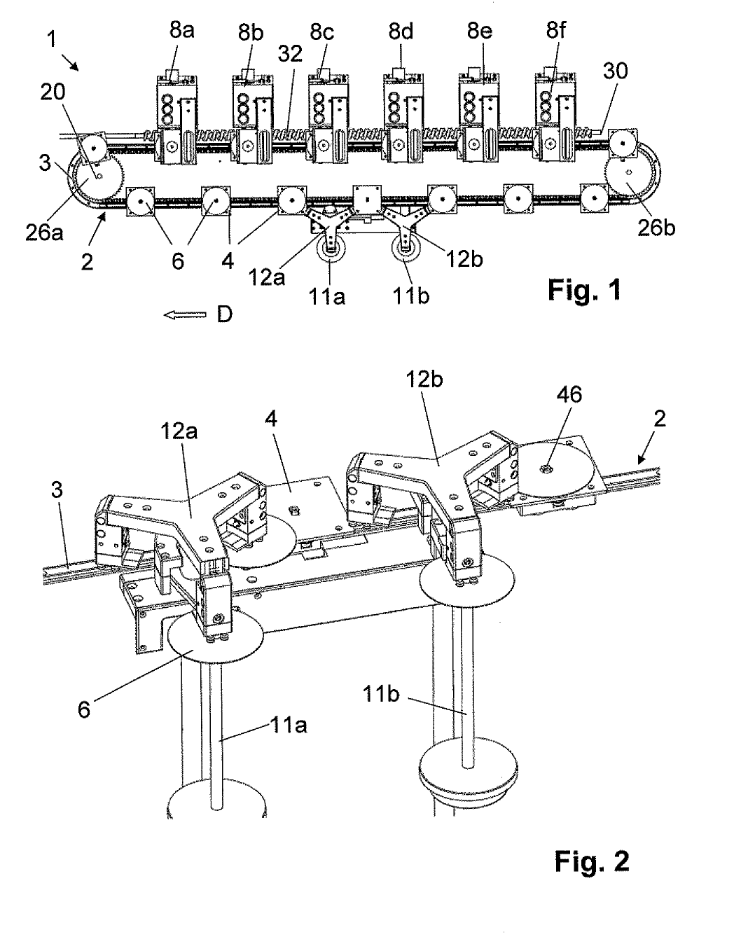

FIG. 1 shows a schematic view of the device 1 according to a first embodiment of the invention. The device is intended for processing of articles such as CDs, DVDs or the like and comprises a conveyor path 2 along which a number of palettes 4 that are supporting articles 6 to be processed are guided in an orbit in a direction D around the conveyor path 2. At least one processing station 8A-F is placed in connection to the conveyor path 2. Such a processing station might e.g. be a processing station at which the article is provided with a print. Suitably, several printing stations 8A, 8C and 8D are situated one after another along the conveyor path with a subsequent curing station 8B, 8D and 8F for curing the recently applied print, and situated after each printing station.

The articles 6 arrive at the conveyor path piled on a first bar 11a, whereby a picking unit 12A picks them up, one by one, and places them on palettes that are driven forward in a direction along the conveyor path 2. A second picking unit 12B removes the articles from the conveyor path when they are fully processed and places them on a second bar 11b.

The device 1 according to the invention comprises two driving devices 20 and 30. The first driving device 20 extends all along the orbit and is arranged to drive the palettes 4 by a first driving element 22, consisting of a continuous chain, which by means of a catch 24 is engaged with the first pin 41 on the palette 4. Catches 24 are firmly arranged on the chain 22 on even intervals, one for each palette 4. It is of course possible to use other driving elements than a chain, such as a belt or wire. In the shown embodiment the chain runs around two gear wheels 26a and 26b, one on either end of the conveyor path 2, where at least one gear wheel is driven by a motor (not shown).

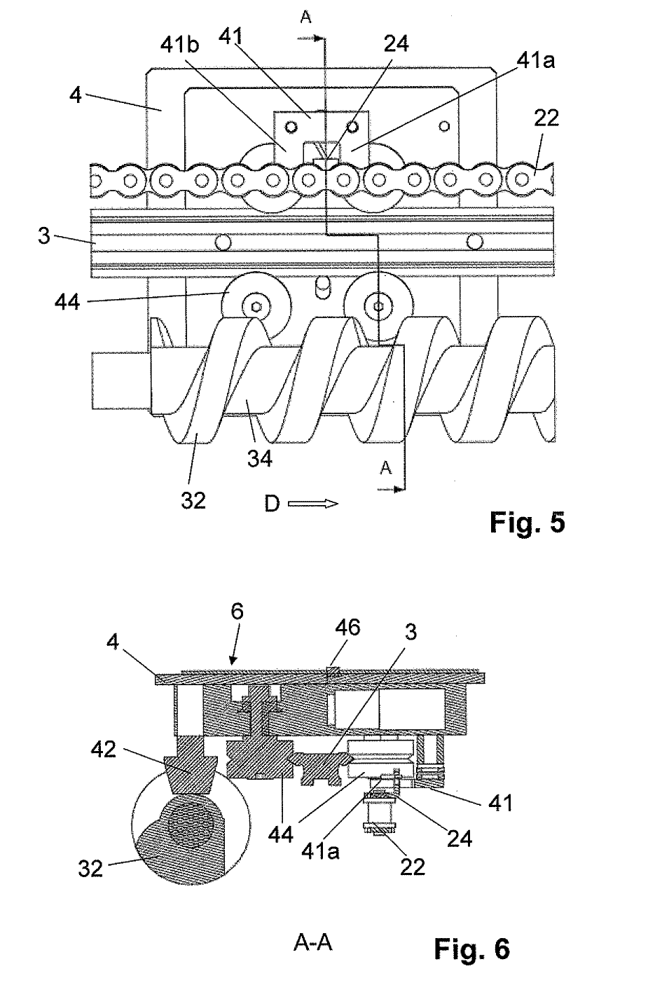

The second driving device 30, which overlaps the first driving device 20, is arranged to drive the palettes 4 at a part of the conveyor path immediately before, at, and immediately after the processing stations 8a-f. For this purpose the second driving device 30 comprises a second driving element 32 that is arranged to engage with the second pin 42 on the palette. In the first embodiment, which is shown in FIGS. 1, 3-6, the second driving element 32 consists of a worm conveyor with a helical curve shaped track 34, in which the second pin 42 is adapted to run. It is important that the second driving device 30 provides an accurate drive, which in this case is provided by means of a high precision worm conveyor in engagement with some type of pin according to the first embodiment.

In FIG. 1 all the processing stations 8a-f are arranged along one worm conveyor 32. It is however also possible to arrange several worm conveyors along the conveyor path, e.g. a worm conveyor might be arranged for each processing station. A restriction is however that a worm conveyor only may guide a palette straight a head and is therefore not alone able to drive a palette in an orbit.

To minimize the problem residing from that the palette 4 gets stuck between the two driving devices the first driving device 20 is arranged to be able to drive the palettes 4 all along the orbit by itself. However, the engagement between the catch 24 of the first driving element 22 and the first pin 41 on the palette includes an allowance, which allows the second driving device 30 to grip the second pin 42 on the palette and drive the palette by itself at said part of the conveyor path. On the other hand, the engagement between the second pin 42 and the second driving element 32 comprises a minimal allowance such that the movement of the palette past the processing stations becomes as accurate as possible. Also, the movement of course has to be synchronized with the potential movement at the processing stations. When the printing is applied by means of rotating pressing rolls the rotational speed of the pressing rolls must consequently be adapted such that the print applying peripheral surface of the pressing roll has the same speed as the palettes, and the curing stations, which often consist of directional UV-lamps, are adapted to only emit TV-radiation when a palette passes directly under them. Such synchronization is however well known to the person skilled in the art (see e.g. U.S. Pat. No. 5,502,310) and will not be processed in detail in this application.

The allowance between the first driving element 22 and the palette 4 might either derive from that the first pin 41 is flexible in the direction D with respect to the palette 4 or that there is a certain allowance between the first driving element 22 and the first pin 41. In the simplest embodiment the first driving element is driving the palette by simply pushing the first pin 41 forward, without any constructional details for preventing the pin to be moved ahead of the driving element. However, in the first embodiment the palette 4 is equipped with a U-shaped first pin 41 with two parallel branches 41a and 41b, which define a space between them, in which the catch 24 of the first driving element might move about freely.

Possibly the first pin 41 might be attached with a resilient allowance in respect of the palette. The resilient allowance should be flexible enough not to interfere with the transfer of the second driving element of the driving of the palette at the same time as it is sufficiently flexible to ensure that the palette is driven forward at a constant speed by the first driving element 22. The resilient allowance might either be included in the attachment of the pin to the palette or in the attachment of the catch 24 to the first driving element 22.

Before the palette 4 has reached a first processing station 8a the second driving element 32, i.e. the worm conveyor, grasps the second pin 42 and moves the palette 4 forward so that the first pin will be situated in front of and no longer will be pushed ahead by the catch 24 of the first driving element 22. This forward displacement in respect of the engagement between the catch and the first pin 41 is achieved due to the fact that the helical curve shaped track 34 of the worm conveyor 32, which is cooperating with the second pin 42 of the palette 4 has a first lead angle in front of the processing station, which is larger than a second lead angle at the processing station such that the palette is displaced forward in relation to the first driving element 22 before reaching the processing station 8a-f. The second angle, which thus prevails at the processing stations 8a-f is adapted such that the palette shall be guided forward at the same speed as when it is guided forward by the first driving device 20. A third angle of the worm conveyor prevails after the processing stations 8a-f, which angle is smaller than the second angle in order to displace the palette backwards in respect of the first driving element, whereby the first pin 41 once again is engaged with the catch 24 after passing the processing stations 8a-f, such that the palette again is driven by the first driving element 22.

Consequently the first pin 41 is displaced forward in relation to the catch 24 at the first lead angle before passing the processing stations, whereby the achieved displacement is kept constant over the central part of the worm conveyor where the palette passes the processing stations 8a-f and is then replaced at the third lead angle after passing the processing stations.

In order for the transfers between the two driving devices 20 and 30 to run smoothly, i.e. in order for the second pin to be smoothly collected in the helical curve shaped track 34 and to be smoothly headed over, the helical curve shaped track preferably comprises a narrowing allowance in respect of the second pin at the first lead angle and possibly also an increasing allowance at the third lead angle, whereby the driving may once again be performed by the first driving element without dislocations.

The device is adapted for a specially designed palette 4. As indicated above the palette 4 comprises a first pin 41 arranged to be engaged with a first driving element 22 on a first driving device 20 to guide the palette forward along a conveyor path 2 including at least one processing station 8a-f. It also comprises a second pin 42 arranged to be engaged with a second driving element 32 on a second driving device 30. The first pin 41 is designed such that its engagement with the first driving element 22 includes an allowance, which allows the palette 4, due to the fact that the second pin 42 is arranged to have a narrower engagement with the second driving element 32 along the portion of the path past the processing station, to be displaced in relation to the first driving element 22.

Further, the palette 4 comprises a fixing element 46 for fixing the articles 6 to it. In a preferred embodiment the fixing element 46 consists of two supporting elements adapted to hold the articles 6 by their centre holes. The supporting elements are pressed against each other when the articles are being placed on or withdrawn from the palette 4 and are at between pushed apart, whereby they are exerting a pressure at each side of the centre hole of the articles, whereby the articles are fixed on the palettes 4. In the cases where the articles do not have a centre hole the articles may be fixed by supporting elements, which engages with the outer edges of the articles or by means of a sub pressure.

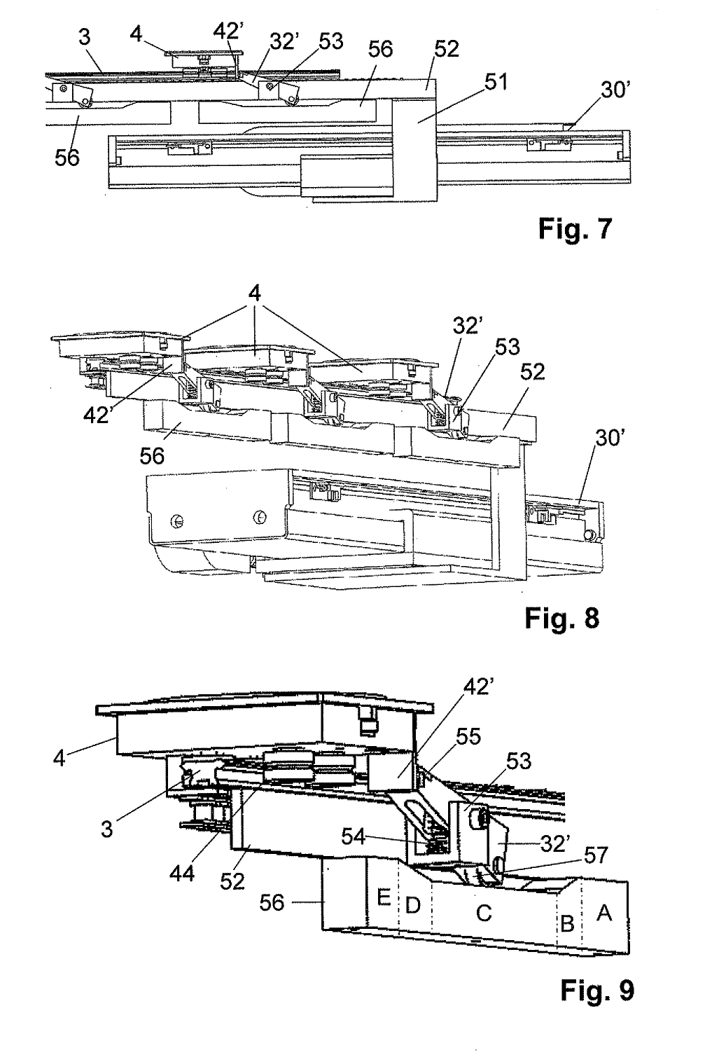

In a second embodiment, which is shown in the FIGS. 7-9, the second driving device consists of a linear feeder 30′ that is connected through a transmission arm 51 and a driving rail 52 to a number of tiltable feeding arms 32′. The tiltable feeding arms constitutes the second driving element in the second embodiment. The driving rail 52 passes all of the processing stations, whereby a tiltable feeding arm 32′ is connected to it at each processing station. Every tiltable feeding arm 32′ is arranged in a holder 53 that allows it to tilt up and down. Further the feeding arm 32′ travels over a cam 56, whereby a wheel 57 on the feeding arm 32′ is adapted to be in continuous connection with the cam. A spring 54, preferably a helical spring, is arranged between the feeding arm 32′ and the holder 53. The spring is arranged such that the tiltable feeding arm is tilted downwards in such a way that the wheel 57 is kept in continuous connection with the cam.

The cam 56 is divided into five parts 56 A-E; two flat elevated parts 56 A and E, one flat lowered middle part 56 C and two inclined parts 56 B and D that are interconnecting the lowered middle part 56 C with each one of the two inclined parts 56 B and D. The purpose of the different parts is to guide the upper end of the feeding arm 32′ vertically at the specific parts. The upper end of the feeding arm 32′ is provided with a permanent magnet 55, which is arranged to be engaged with a second pin 42′, which is assembled on each of the palettes 4. In this second embodiment the pin 42′ consists of a magnetic sheet. Due to the design of the cam 56 and the guiding of the linear feeder the magnet 57 will only abut the magnetic sheet 42′ at the middle part 56 C and partly at the upwards inclined part 56 D. The feeding arms are moved in cycles and are adapted to drive the palettes 4 past the individual processing station, at which they are arranged.

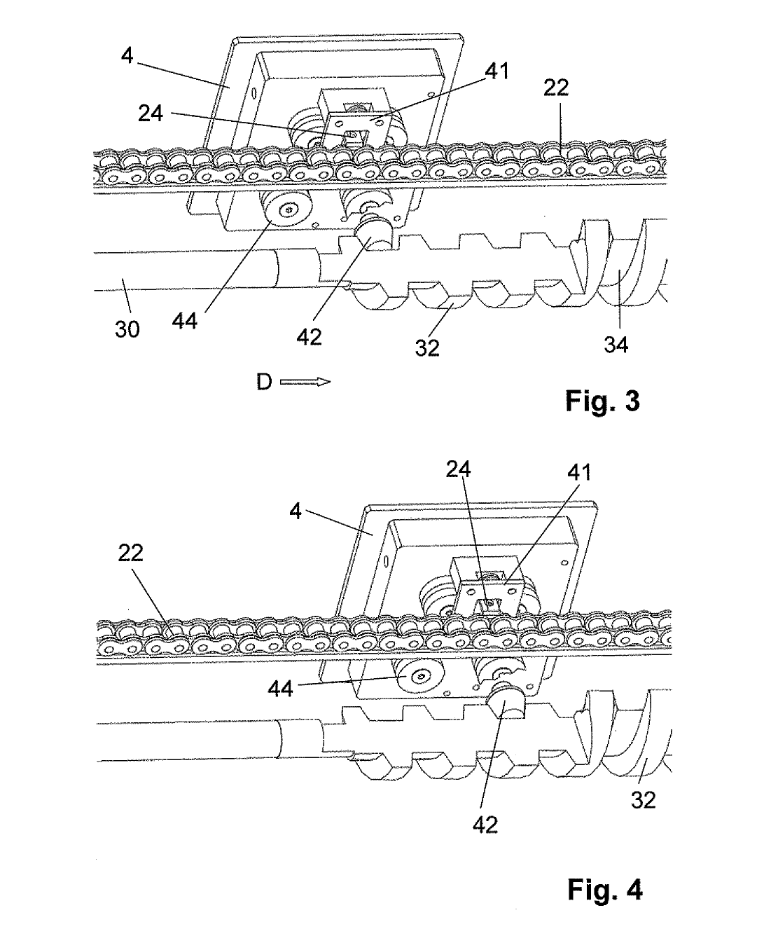

The cycle might for the sake of simplicity be said to start when the feeding arm is placed in the first elevated part 56 A, in which its front end with the magnet 55 is lowered so that the palette 4 and the magnetic sheet 42′ might freely pass over it. Shortly after the palette 4 has passed the feeding arm 32′ the linear feeder 30′ will actuate the driving rail 52 so that each of the feeding arms 32′ that are connected to the driving rail 52 will move towards each palette. The feeding arm 32′ is thus accelerated at the downwards inclined part 56 B, in which the upper end of the feeding arm is tilted upwards to a position where it will follow closely behind the magnetic sheet 42′ of the palette 4. Right at the beginning of the flat lowered middle part 56 C in the cam the magnet 55 of the feeding arm 32′ connects to the magnetic sheet 42′, whereby the palette is displaced forward in relation to the first driving element 22 and is only driven by the engagement between the magnet 55 and the magnetic sheet 42′ until the feeding arm at the upwards inclined part 56 D of the cam 56 is lowered so that the magnet 55 ends up under the magnetic sheet 42′ and the engagement there between will be broken, whereby the palette once again will be driven by the engagement between the first driving element 22 and the first pin 41, see FIGS. 3-4. Shortly after the feeding arm 32′ has reached the last flat part 56 E of the cam and after the palette 4 has passed the feeding arm 32′ the feeding arm is guided back in one quick movement to the starting position in the first part 56 A of the cam, where it will await the next palette before the next cycle will be started.

As the case for the first embodiment the speed of the linear motor is such adapted that the palette is driven at the same speed past the processing stations as at the parts where it is driven by the first driving device. Consequently the linear motor is decelerated from the faster initial speed shortly after that the magnet of the feeding arm 32′ has reached and abutted the magnetic sheet 42′ on the palette 4.

1. Device for processing of articles such as CDs, DVDs or the like, which comprises:
a conveyor path comprising a rail,
at least one processing station placed along the conveyor path,
at least one palette, which is arranged to carry an article that is to be processed, and which is arranged in engagement with the rail of the conveyor path and is driven in an orbit in a direction around the conveyor path by two separate driving devices;
a first driving device, which extends along the whole conveyor path and is arranged to drive the palette along the conveyor path by means of a first driving element in engagement with a first pin on the palette,
a second driving device, which is overlapping the first driving device and is arranged to drive the palette past the processing stations by means of a second driving element that is engaged with a second pin on the palette, characterized in that the second driving element is arranged to engage the second pin on the palette before the palette has reached the processing station, whereby the engagement between the first driving element and the first pin comprises an allowance, which allows the second driving device to drive the palette past the processing station within said allowance and without influence of the engagement between the first driving element and the first pin.

2. Device according to claim 1, characterized in that the first pin and the second pin are interconnected.

3. Device according to claim 1, characterized in that the second driving element consists of a worm conveyor including a helical curve shaped track, in which the second pin is arranged to come in sliding engagement to guide the palette forward in direction, wherein the worm conveyor with the helical curve shaped track is adapted to drive the palette forward at substantially the same speed past the processing stations as in the parts where it is driven forward by the first driving element.

4. Device according to claim 3, characterized in that the worm conveyor has a first lead angle before the processing station, which is greater than a second lead angle of the worm conveyor right at the processing station such that the first pin is displaced forward in respect of the first driving element before arriving at the processing station and a third lead angle after passing the processing station, which is smaller than the second lead angle such that the first pin is displaced backwards in respect of the first driving element after passing the processing station, wherein the palette once again is driven by the first driving element.

5. Device according to claim 1, characterized in that the second driving device is a linear motor and in that the second driving element consists of a thereto connected feed arm that is arranged to engage with the second pin at the palette to drive the palette past at least one processing station.

6. Device according to claim 5, characterized in that the linear motor is linked to several feed arms, whereby each feed arm is adapted to drive the palette past one processing station.

7. Device according to claim 5, characterized in that each feed arm is provided with a magnet and that the second pin consists of a magnetic sheet to which the magnet is attracted and with which it will engage when the feed arm is close enough to the palette.

8. Device according to claim 7, characterized in that the feed arm due to the driving of the linear motor is driven in a cycle, in which it starts out from a stationary position where the palette may pass the feed arm without being impeded by the arm, whereupon the feed arm is erected and is accelerated towards the palette until the magnets is engaged with the magnetic sheet, whereby the palette is forwardly displaced within the allowance between the first pin and the first driving element, whereupon the feed arm is decelerated so that the palette is driven past the processing station with a speed that is substantially the same as the speed of the palette when driven by the first driving device, such that the clearance between the first pin and the first driving element remains substantially constant, whereupon the feed arm is retracted after the palette has passed the processing station such that the engagement between the magnet and the magnetic sheet is broken, whereupon the feed arm is guided back to the starting position to await the following palette.

9. Device according to claim 1, characterized in that the first driving element comprises a spring, which strives to minimize the allowance between the first driving element and the first pin, whereby the engagement between the second driving element and the second pin exceeds the spring action to make it possible for the second driving device to drive the palette past the processing station without influence of the spring action.

10. Device according to claim 1, characterized in that the first driving element consists of a chain.

11. Palette for supporting articles such as CDs, DVDs or the like, which is adapted to be guided forward on a conveyor path on a device according to any of the proceeding claims, the palette comprising:
a wheel or the like arranged to interact with a rail along the conveyor path,
a first pin arranged to engage with a first driving element on a first driving device to drive the palette forward along the rail of the conveyor path,
a second pin arranged to engage with a second driving element on a second driving device, characterized in that the engagement of the first pin with the first driving element includes an allowance, which by means of the engagement between the second driving element on the second driving device allows the palette to be displaced in respect of the first driving element, such that the palette may be driven forward by the second driving element within said allowance.
